(19) United States
(12) Patent Application Publication
(10) Pub. No.: US 2016/0144783 A1
(43) Pub. Date: May 26, 2016

(54) Method for vehicle occupancy reminding

(71) Applicant: Janek Jakob Mroczek, Utica, NY (US)

(72) Inventor: Janek Jakob Mroczek, Utica, NY (US)

(21) Appl. No.: 14/947,677

(22) Filed: Nov. 20, 2015

Related U.S. Application Data
(60) Provisional application No. 62/082,721, filed on Nov. 21, 2014.

(51) Int. Cl. B60Q 9/00

(52) U.S. Cl. CPC B60Q 9/00

(57) ABSTRACT

A vehicle occupancy reminder for reminding driver or caretaker to not leave occupant(s) in the vehicle. The invention is configured to be attached to any part of a vehicle and/or keyring. Moreover, the invention may be configured with attachment to child car seat. Power may be provided by battery housed inside the invention and/or by the vehicle's power. The invention includes an activator and at least one emitter such as sound, light, or vibration. The activator is controlled by the vehicle's door. Moreover, the invention may be turned ON or OFF with an on/off switch.

### CROSS-REFERENCE TO RELATED APPLICATIONS

This invention was previously filed as provisional patent on Ser. No. 11/21/2014, application number 62/082721, confirmation number 8289.

### REFERENCE TO SEQUENCE LISTING

Not Applicable

### BACKGROUND OF THE INVENTION

### 1. Field of the Invention:

This invention is in the field of automobile occupancy reminding system, specifically a reminder to not leave child(ren) in vehicle.

2. Description of the Related Art:

Some of the existing art for occupancy, child(ren), reminders are:
1. Placing a reminder sticker on a vehicle's window. One of the drawbacks of this method is that the driver, or caretaker of the child(ren), needs to remember to look at the sticker.
2. Hanging a reminder tag from the rear view mirror. One of the drawbacks of this method is that the driver, or caretaker of the child(ren), needs to remember to look at the tag.
3. Attaching a reminding non-electronic tag to key(s) ring. One of the drawbacks of this method is that the driver, or caretaker of the child(ren), might place the tag into a pocket, purse, bag, or other storage method, thus not seeing the reminding tag during the departure of the vehicle. Moreover, the non-electronic tag does not actively sound any alarms if a child is left in the vehicle.
4. Sensor(s) placed in the child seat-belt buckle that that communicate by a wireless method to a receiver. The premise is that the seat-belt buckle will be closed when a child is present in the vehicle, and if the receiver is at some distance away from the sensor an alarm will sound that a child was left in the vehicle. One of the drawbacks of this method is that the reminder, alarm, does not activate unless the driver, or caretaker, is away from the vehicle by a distance of several feet.

### BRIEF SUMMARY OF THE INVENTION

The present invention is a reminder that activates when a vehicle door is open(ed). The present invention comprises of: an activator, such as, but not limited to, a switch; control board; and an audio and/or a visual and/or a vibration emitter. Wherein the emitter(s) is (are) active when the door of the vehicle is open. The reminder continues to be active while the vehicle door is open (ajar). Some of the methods of conveying a reminder may be, but are not limited to,:
1. Audio of single or multiple frequencies
2. Speech
3. Flashing or steady light
4. Vibration

To convey a reminder it is sufficient to have only one method, but may include multiple methods and is not limited to the number of methods used in conveying a reminder. The present invention can be an “after market” system that can be installed in a vehicle, or can be part of a vehicle during a vehicle's design, engineering, and production.

### BRIEF DESCRIPTION OF THE DRAWINGS

FIG. 1 is a perspective view, showing the present invention.

FIG. 2 is an alternate perspective view, showing the present invention.

FIG. 3 is an alternate configuration, showing the present invention.

FIG. 4 shows internal components of the invention.

FIG. 5 is a schematic view, showing the various components of the invention.

FIG. 6 is a possible installation method, showing the invention attached to the dashboard.

FIG. 7 is an alternate installation method, showing the invention installed as an internal component of the vehicle.

FIG. 8 is an alternate installation method, showing the invention installed without any external cables.

FIG. 9 is an alternate installation method, showing the invention connected to child car seat.

FIG. 10 is an alternate installation method, showing the invention connected to child car seat by a wireless method.

FIG. 11 is an alternate installation method, showing the invention attached to a keyring.

### REFERENCE NUMERALS IN THE DRAWINGS

| | |
|---|---|
| 6 | Vibration emitter |
| 8 | Reminder Unit |
| 10 | Activator |
| 11 | Magnetic Activator |
| 12 | Cable |
| 14 | Housing |
| 16 | Sound Emitter |
| 18 | Light Emitter |
| 20 | On/Off Switch |
| 21 | Child Car Seat |
| 22 | Control Board |
| 24 | Power Source |
| 26 | Cover |
| 28 | Steering Wheel |
| 30 | Dashboard |
| 32 | Door |
| 34 | Keyring |
| 38 | Wireless receiver |
| 40 | Wireless transmitter |

### DETAILED DESCRIPTION

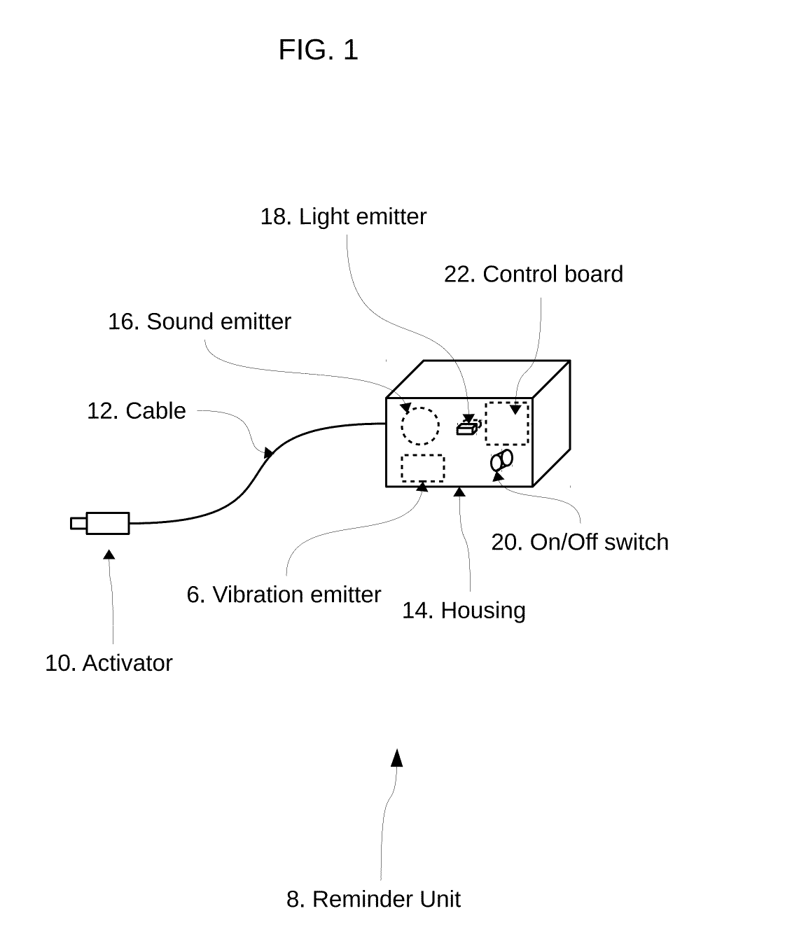

FIG. 1 shows a perspective view of the present invention in an assembled state. Reminder system 8 consists of an activator 10 and housing 14, which contains various components. Cable 12 connects an activator 10 to control board 22 inside housing 14. Alternatively an activator 10 can send a signal to the control board 22 by a wireless method. Purpose of an activator 10 is to send an activate signal to control board 22 when car door is open, and to send an deactivate signal to control board 22 when car door is closed. When the control board 22 receives activate signal it provides an alerting reminder to the driver/caretaker by the sound emitter 16, and/or the light emitter 18, and/or the vibration emitter 6. When the control board 22 receives deactivate signal, it stops the reminder system 8 from emitting sound, light, and/or vibration. Optionally an On/Off switch 20 may be included to turn OFF the reminder system 8 when not needed, such as when the car door will be open for prolonged time during cleaning or maintenance of the vehicle. The On/Off switch 20 may optionally be used turn ON the reminder system 8 when child will be present in the vehicle and OFF when no child will be present in the vehicle. Optionally the reminder system 8 may contain a vibration emitter 6, such option provides vibration alerting to the driver/caretaker when the reminder system is attached to keyring and/or placed inside a pocket or hand.

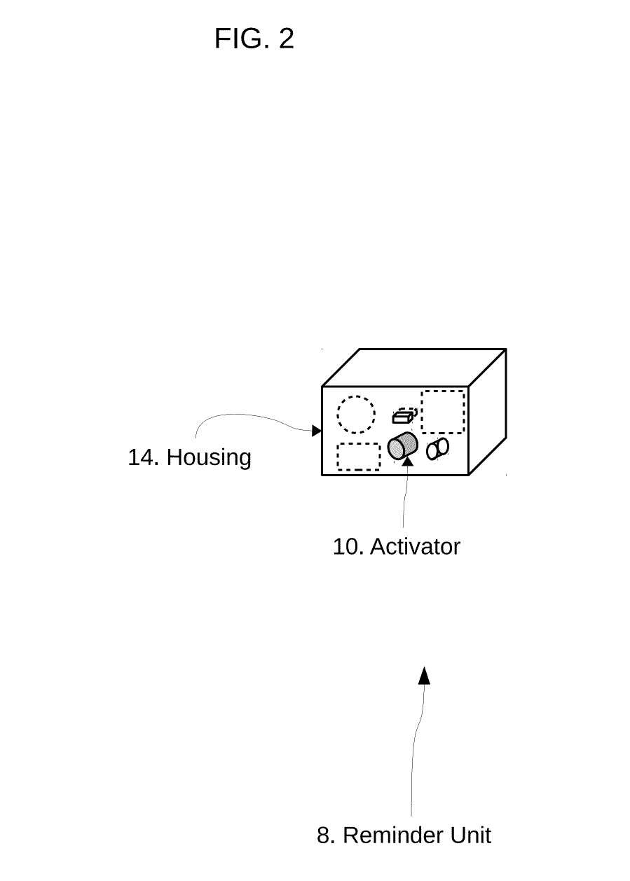

FIG. 2 shows a perspective view of the invention, reminder unit 8, with the activator 10 located at the housing 14.

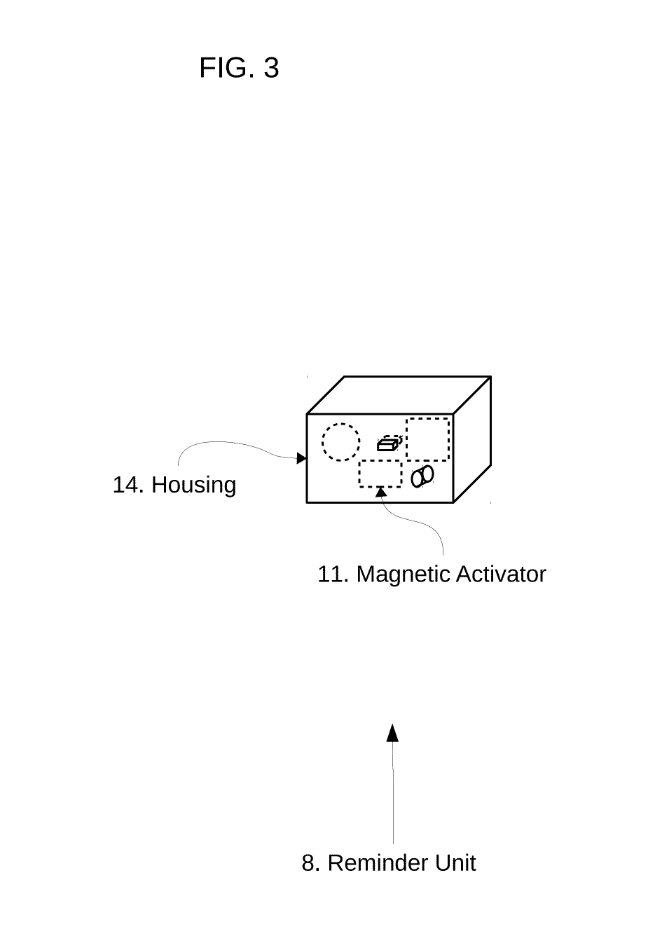

FIG. 3. shows an alternate configuration of the invention, the reminder unit 8 alternatively can be activated using magnetic activator 11 located inside the housing 14.

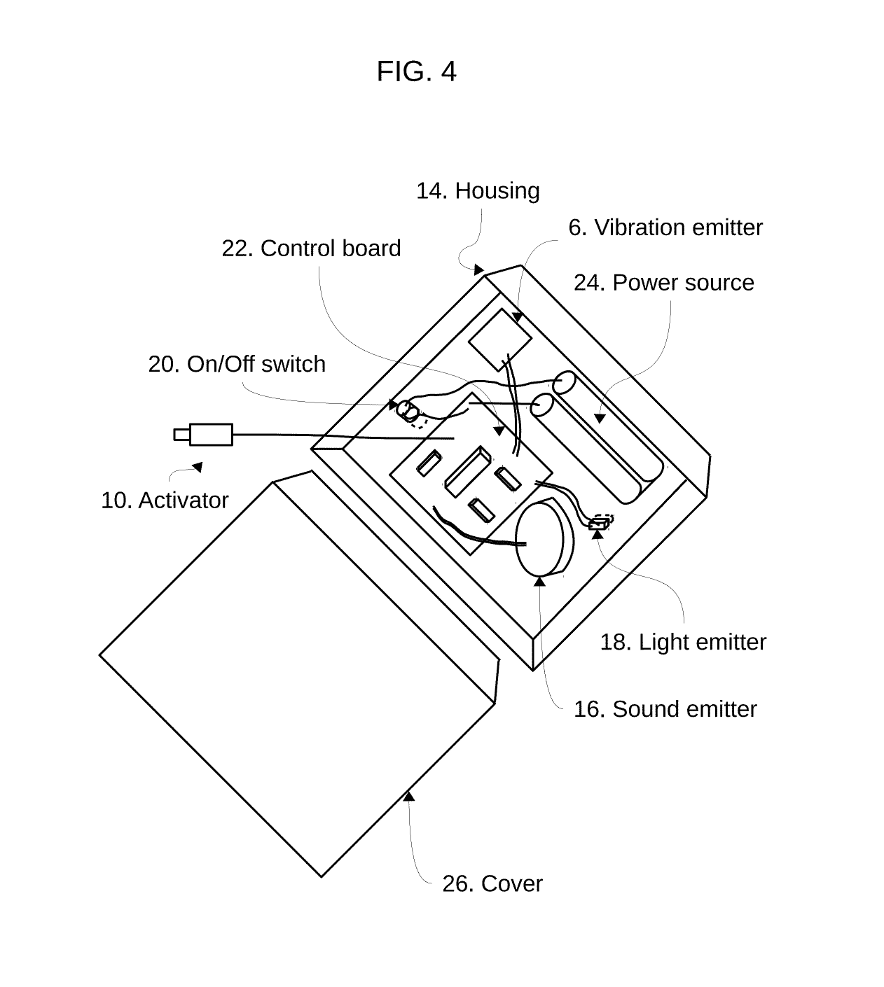

FIG. 4 shows an example of how the components inside the housing are connected. In this example an activator 10, sound emitter 16, light emitter 18, vibration emitter 6, one of the power source 24 wires, and one of the On/Off switch 20 wires are connected to the control board 22. The second wire of the On/Off switch 20 is connected to the second wire of the power source 24. Power source 24 may be a single or multiple batteries, or may be the vehicle's power source. The cover 26 attaches to the housing 14 by screw(s), adhesive, latch(es), or any other means of attachment.

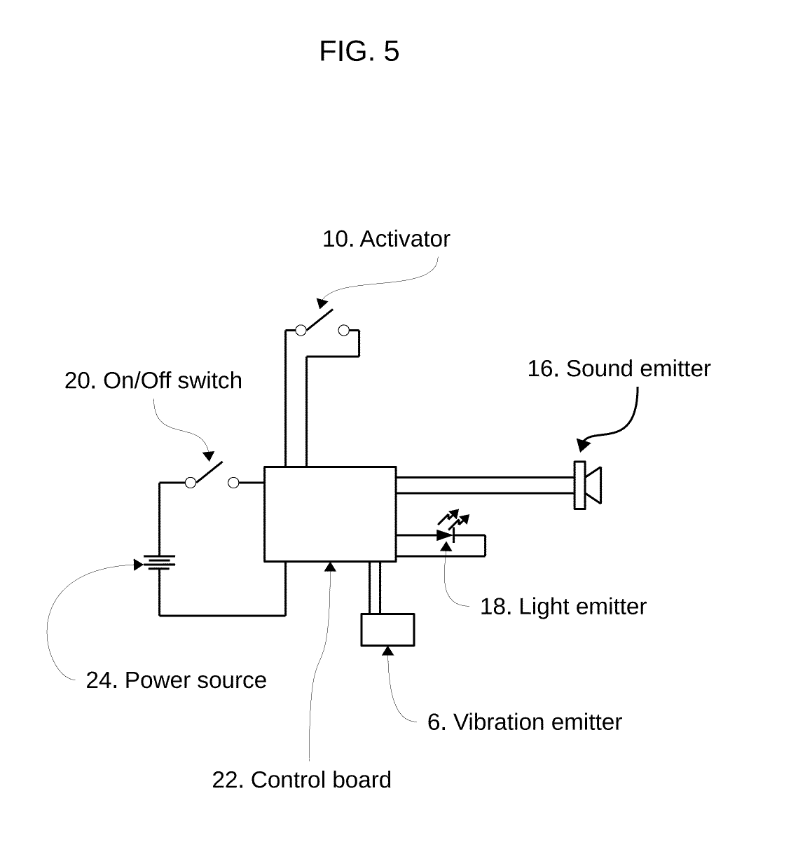

FIG. 5 is a schematic view, showing the various components of the invention. An On/Off switch 20 is provided to connect power source 24 to the control board 22. The activator 10 is connected to the control board 22 and sends signals, to the control board 22, indicating to emit sound through the sound emitter 16, light using a light emitter 18, and/or vibration using a vibration emitter 6. When activator 10 is inactive (open) no sound, light, or vibration is emitted.

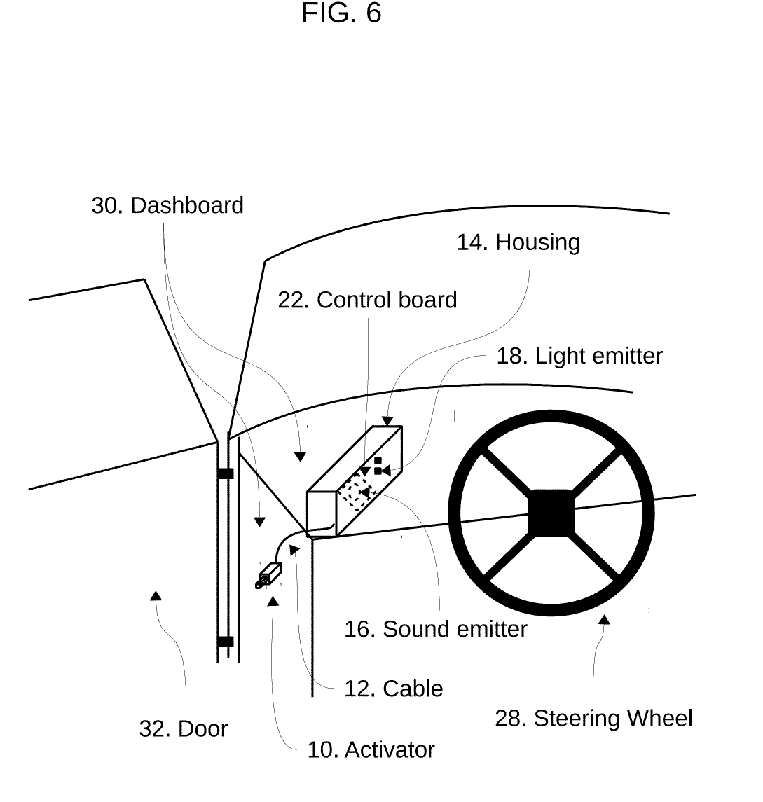

FIG. 6 is a possible installation method, showing the invention attached to a vehicle's dashboard 30. In this example the housing 14 and its contents are attached to the top of the dashboard 30 by any method that will prevent the housing 14 from falling off the dashboard. Preferably the invention is attached in such a way that the sound emitter 16 allows for maximum volume of the audio to reach the driver/caretaker, and that a light emitter 18 is unobstructed from the driver/caretaker view. An activator 10 is attached to the side of the dashboard 30. When the door 32 is open the activator 10 sends an activate signal by a cable 12 to the control board 22. The control board 22 then provides an alerting reminder through the sound emitter 16 and/or light emitter 18 to the driver/caretaker to not leave a child or a passenger in a vehicle. Steering wheel 28 is shown for easier representation of FIG. 6. When door 32 is closed the activator 10 sends a signal to control board 22 to stop the alerting reminder.

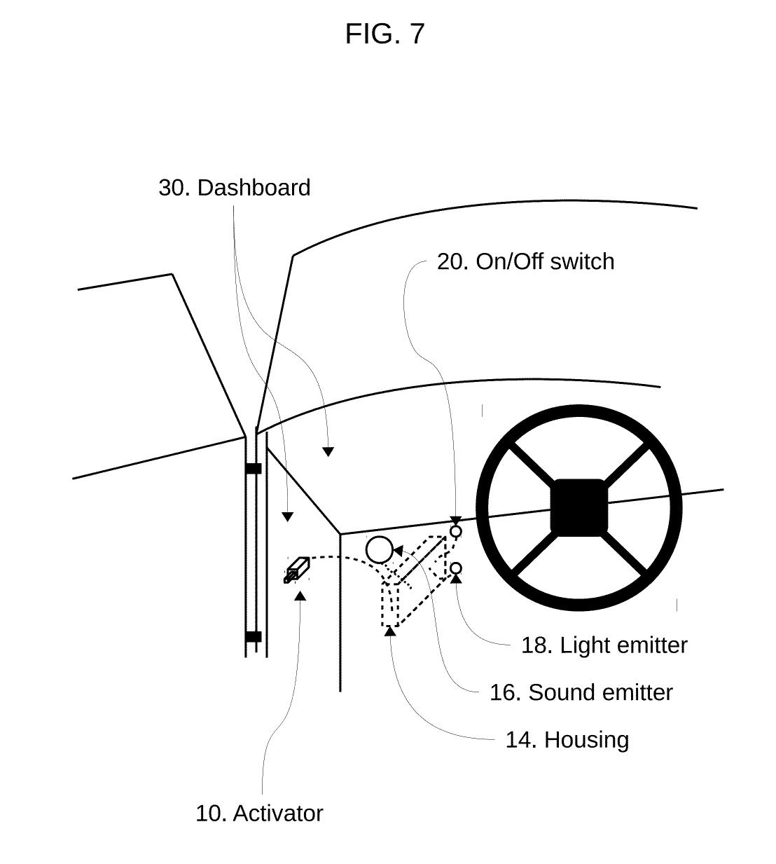

FIG. 7 is an alternate installation method, showing the invention installed inside the dashboard 30. The invention may be mounted inside or underneath the dashboard 30, or may be installed in any location on the vehicle. Also, the sound emitter 16, light emitter 18, and On/Off switch 20 may be mounted outside the housing 14. The activator 10 is still connected to the side of the dashboard 30.

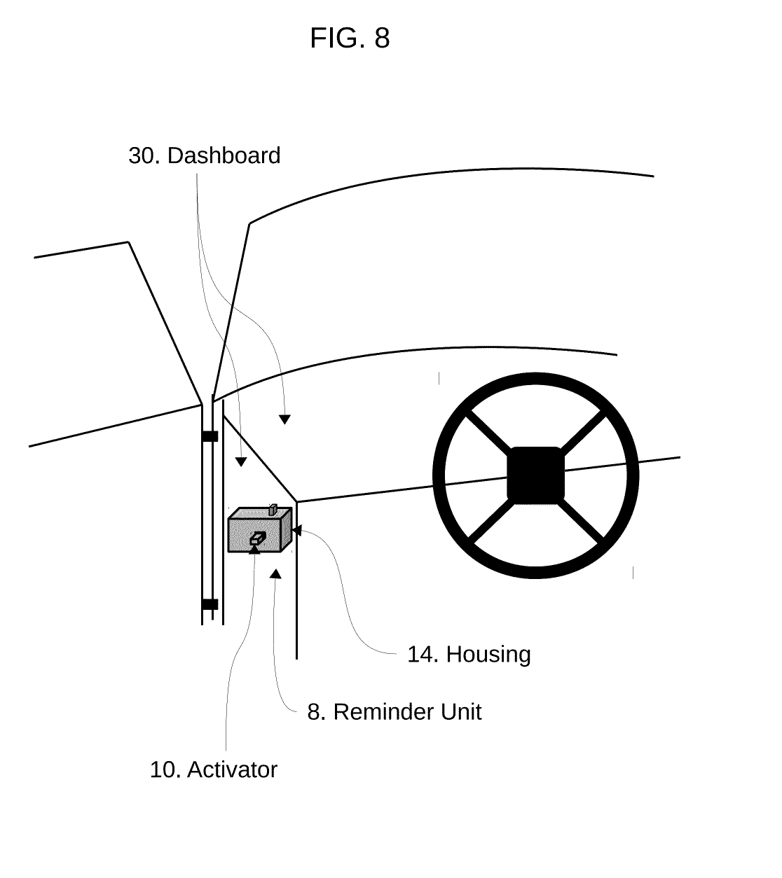

FIG. 8 is an alternate installation method, showing the invention installed without any cables or wires protruding from the housing 14. The reminder unit 8 is installed directly to the side of the dashboard 30 with the activator 10 protruding from the housing 14.

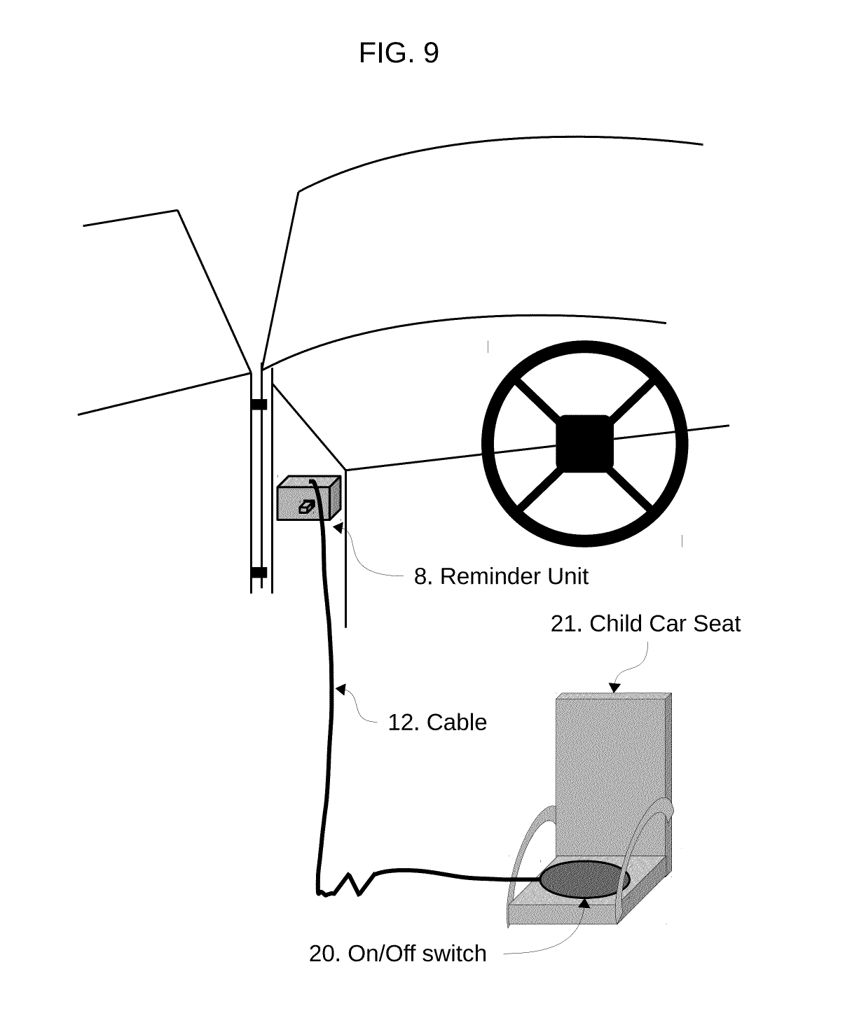

FIG. 9 is an alternate installation method, showing the ON/OFF switch 20 of the invention located at the child car seat 21 by a cable 12. In this configuration the reminder unit 8 turns ON when a child is present in the child car seat 21, and turns OFF when no child is present in the child car seat 21.

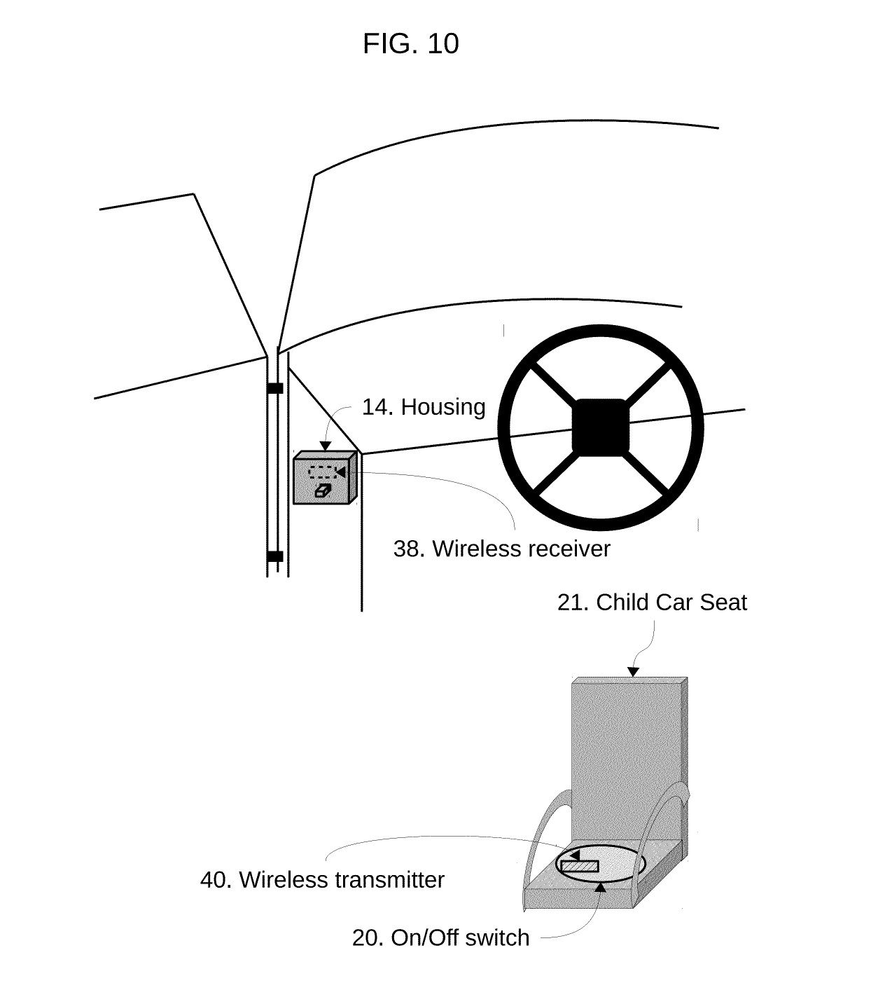

FIG. 10 is an alternate installation method, showing the ON/OFF switch 20 located at the child car seat 21 connected to the wireless receiver 38 inside the housing 14 by a wireless transmitter 40.

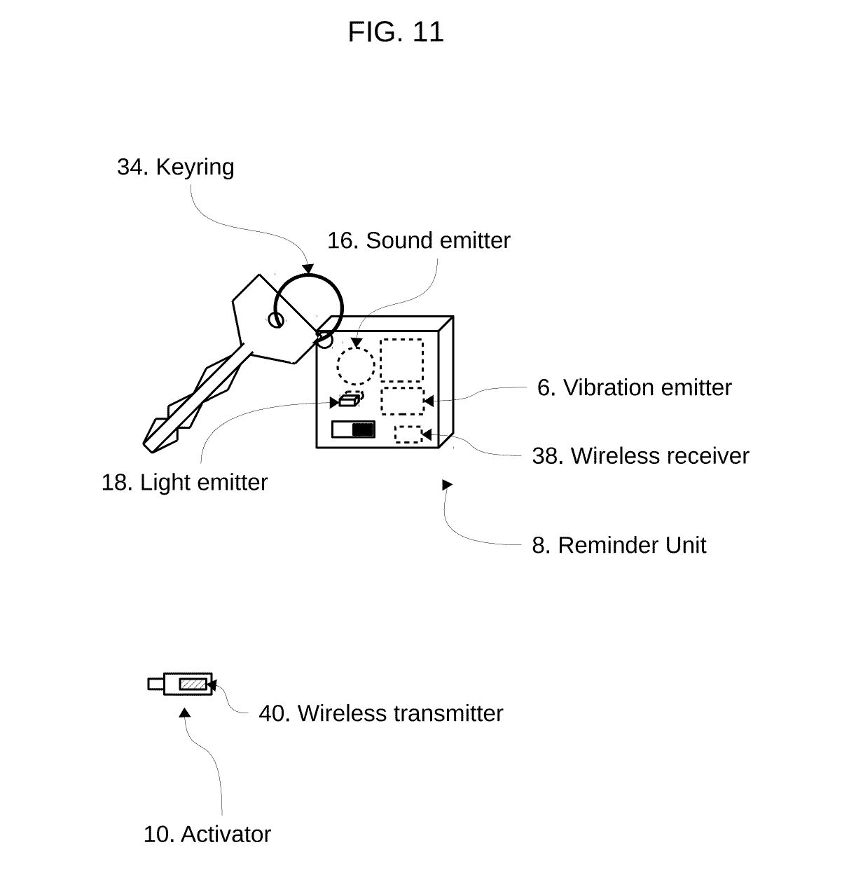

FIG. 11 is an alternate installation method, showing the invention attached to a keyring 34. Alternatively the reminder unit 8 may be attached to a keyring 34. In this installation method the activator 10 sends an activate signal by a wireless method by the wireless transmitter 40 to the wireless receiver 38. The reminder unit 8 may contain vibration emitter 6, sound emitter 16, and light emitter 18.

I claim:

1. A vehicle occupancy reminder system, wherein said reminder system is comprising:
a. an activator;
b. at least one emitter

2. A vehicle occupancy reminder system, as recited in claim 1, wherein said activator is controlled by the vehicle's door.

3. A vehicle occupancy reminder system, as recited in claim 1, configured for attachment to any part of a vehicle.

4. A vehicle occupancy reminder system, as recited in claim 1, optionally configured with an on/off switch located at the child car seat.

5. A vehicle occupancy reminder system, as recited in claim 1, optionally configured with an on/off switched controlled by the presence and/or weight of a child.

6. A vehicle occupancy reminder system, as recited in claim 1, optionally configured with wireless transmitter and/or wireless receiver.

7. A vehicle occupancy reminder system, as recited in claim 1, optionally configured for attachment to a keyring.

8. A vehicle occupancy reminder system, as recited in claim 1, optionally configured with magnetic activator.
